(19) United States
(12) Patent Application Publication
(10) Pub. No.: US 2019/0154125 A1
(43) Pub. Date: May 23, 2019

(54) PLANETARY POWERTRAIN CONFIGURATIONS WITH A BALL VARIATOR CONTINUOUSLY VARIABLE TRANSMISSION USED AS A POWERSPLIT

(71) Applicant: DANA LIMITED, MAUMEE, OH (US)

(72) Inventors: GORDON M. MCINDOE, VOLENTE, TX (US); SEBASTIAN J. PETERS, CEDAR PARK, TX (US)

(73) Assignee: DANA LIMITED, MAUMEE, OH (US)

(21) Appl. No.: 16/301,760

(22) PCT Filed: May 19, 2017
(86) PCT No.: PCT/US2017/033452

§ 371 Date: Nov. 15, 2018

Related U.S. Application Data
(60) Provisional application No. 62/338,921, filed on May 19, 2016.
(60) Provisional application No. 62/365,703, filed on Jul. 22, 2016.
(60) Provisional application No. 62/457,339, filed on Feb. 10, 2017.

(51) Int. Cl. F16H 37/04; F16H 15/28; F16H 3/00; F16H 37/08

(52) U.S. Cl. CPC F16H 37/042; F16H 15/28; F16H 2200/0043; F16H 37/086; F16H 2037/0873; F16H 3/006

(57) ABSTRACT

Devices and methods are provided herein for the transmission of power in motor vehicles. Power is transmitted in a smoother and more efficient manner by splitting torque into two or more torque paths. A continuously variable transmission is provided with a ball variator assembly having an array of balls, a planetary gear set coupled thereto and an arrangement of rotatable shafts with multiple gears and clutches that extend the ratio range of the variator. In some embodiments, a locking clutch is operably coupled to the planetary gear set to selectively couple two of the elements of the planetary gear set during operation. Engagement of the locking clutch corresponds to a fixed ratio operating mode. Disengagement of the locking clutch corresponds to a variable ratio operating mode.

### RELATED APPLICATIONS

The present application claims the benefit of U.S. Provisional Application No. 62/338,921 filed on May 19, 2016, U.S. Provisional Application No 62/365,703 filed on Jul. 22, 2016, and U.S. Provisional Application No 62/457,339 filed on Feb. 10, 2017, which are incorporated herein by reference in its entirety.

### BACKGROUND

A driveline including a continuously variable transmission allows an operator or a control system to vary a drive ratio in a stepless manner, permitting a power source to operate at its most advantageous rotational speed.

### SUMMARY

Provided herein is a continuously variable transmission having: a first rotatable shaft operably coupleable to a source of rotational power; a second rotatable shaft coaxial with the first rotatable shaft, the first rotatable shaft and the second rotatable shaft forming a main axis; a third rotatable shaft aligned parallel to the main axis; a fourth rotatable shaft arranged coaxial to the main axis, the fourth rotatable shaft configured to transmit an output power; a variator assembly having a first traction ring assembly and a second traction ring assembly in contact with a plurality of balls, wherein each ball of the plurality of balls has a tillable axis of rotation, the variator assembly is coaxial with the main axis, the first traction ring assembly is operably coupled to the second rotatable shaft; a planetary gear set having a sun gear operably coupled to the second rotatable shaft, a planet carrier operably coupled to the first rotatable shaft and a ring gear coupled to the second traction ring assembly; a first-and-third mode clutch coaxial with, and coupled to, the third rotatable shaft; a second-and-fourth mode clutch coaxial with, and coupled to, the third rotatable shaft; a first gear set operably coupled to the first-and-third mode clutch; a second gear set operably coupled to the second-and-fourth mode clutch; a third gear set operably coupled to the first-and-third mode clutch; a fourth gear set operably coupled to the second-and-fourth mode clutch; a first synchronizer clutch operably coupled to the first gear set; a second synchronizer clutch operably coupled the second gear set; a third synchronizer clutch operably coupled to the third gear set; and a fourth synchronizer clutch operably coupled to the fourth gear set, wherein the first synchronizer clutch, the second synchronizer clutch, the third synchronizer clutch, and the fourth synchronizer clutch are operably coupled to, and coaxial to, the fourth rotatable shaft.

Provided herein is a continuously variable transmission having: a first rotatable shaft operably coupleable to a source of rotational power; a second rotatable shaft coaxial with the first rotatable shaft, the first rotatable shaft and the second rotatable shaft forming a main axis; a third rotatable shaft aligned parallel to the main axis; a fourth rotatable shaft arranged coaxial with the third rotatable shaft, the third rotatable shaft and the fourth rotatable shaft forming a counter axis; a fifth rotatable shaft arranged coaxial to the main axis, the fifth rotatable shaft configured to transmit an output power; a variator assembly having a first traction ring assembly and a second traction ring assembly in contact with a plurality of balls, wherein each ball of the plurality of balls has a tiltable axis of rotation, the variator assembly is coaxial with the main axis, the first traction ring assembly is operably coupled to the second rotatable shaft; a planetary gear set having a sun gear operably coupled to the second rotatable shaft, a planet carrier operably coupled to the first rotatable shaft and a ring gear coupled to the second traction ring assembly; a first-and-third mode clutch coaxial with, and coupled to, the second rotatable shaft; a second-and-fourth mode clutch coaxial with, and coupled to, the second rotatable shaft; a first-and-third mode gear set operably coupled to the first-and-third mode clutch, the first-and-third mode gear set operably coupled to the third rotatable shaft; a second-and-fourth mode gear set operably coupled to the second-and-fourth mode clutch, the second-and-fourth mode gear set operably coupled to the fourth rotatable shaft; a first gear set operably coupled to the third rotatable shaft; a second gear set operably coupled to the fourth rotatable shaft; a third gear set operably coupled to the third rotatable shaft; a fourth gear set operably coupled to the fourth rotatable shaft; a first synchronizer clutch operably coupled to the first gear set; a second synchronizer clutch operably coupled the second gear set; a third synchronizer clutch operably coupled to the third gear set; and a fourth synchronizer clutch operably coupled to the fourth gear set, wherein the first synchronizer clutch, the second synchronizer clutch, the third synchronizer clutch, and the fourth synchronizer clutch are operably coupled to, and coaxial to, the fifth rotatable shaft.

Provided herein is a continuously variable transmission having: a first rotatable shaft operably coupleable to a source of rotational power; a second rotatable shaft coaxial with the first rotatable shaft, the first rotatable shaft and the second rotatable shaft forming a main axis; a third rotatable shaft aligned parallel to the main axis; a fourth rotatable shaft arranged coaxial to the main axis, the fourth rotatable shaft arranged parallel to the third rotatable shaft; a fifth rotatable shaft arranged coaxial with the fourth rotatable shaft; a sixth rotatable shaft arranged coaxial with the fifth rotatable shaft, the sixth rotatable shaft configured to transmit an output power; a variator assembly having a first traction ring assembly and a second traction ring assembly in contact with a plurality of balls, wherein each ball of the plurality of balls has a tiltable axis of rotation, the variator assembly is coaxial with the main axis, the first traction ring assembly is operably coupled to the second rotatable shaft; a planetary gear set having a sun gear operably coupled to the second rotatable shaft, a planet carrier operably coupled to the first rotatable shaft and a ring gear coupled to the second traction ring assembly; a first-and-third mode clutch coaxial with, and coupled to, the fourth rotatable shaft; a second-and-fourth mode clutch coaxial with, and coupled to, the fifth rotatable shaft; a transfer coupling configured to couple to the second rotatable shaft and the third rotatable shaft; a first gear set operably coupled to the fourth rotatable shaft; a second shaft; a first gear set operably coupled to the fourth rotatable shaft; a second gear set operably coupled to the fifth rotatable shaft; a third gear set operably coupled to the fourth rotatable shaft; a fourth gear set operably coupled to the fifth rotatable shaft; a first synchronizer clutch operably coupled to the first gear set; a second synchronizer clutch operably coupled the second gear set; a third synchronizer clutch operably coupled to the third gear set; and a fourth synchronizer clutch operably coupled to the fourth gear set, wherein the first synchronizer clutch, the second synchronizer clutch, the third synchronizer clutch, and the fourth synchronizer clutch are operably coupled to, and coaxial to, the third rotatable shaft.

Provided herein is a continuously variable transmission having: a first rotatable shaft operably coupleable to a source of rotational power; a second rotatable shaft coaxial with the first rotatable shaft, the first rotatable shaft and the second rotatable shaft forming a main axis; a third rotatable shaft aligned coaxial to the main axis; a fourth rotatable shaft aligned coaxial to the third rotatable shaft; a fifth rotatable shaft arranged parallel to the main axis; a variator assembly having a first traction ring assembly and a second traction ring assembly in contact with a plurality of balls, wherein each ball of the plurality of balls has a tiltable axis of rotation, the variator assembly is coaxial with the main axis, the first traction ring assembly is operably coupled to the second rotatable shaft; a planetary gear set having a sun gear operably coupled to the second rotatable shaft, a planet carrier operably coupled to the first rotatable shaft, and a ring gear coupled to the second traction ring assembly; a first-and-third mode clutch coaxial with, and coupled to, the second rotatable shaft, the first-and-third mode clutch coupled to the third rotatable shaft; a second-and-fourth mode clutch coaxial with, and coupled to, the second rotatable shaft, the second-and-fourth mode clutch coupled to the fourth rotatable shaft; a first gear set operably coupled to the third rotatable shaft; a second gear set operably coupled to the fourth rotatable shaft; a third gear set operably coupled to the third rotatable shaft; a fourth gear set operably coupled to the fourth rotatable shaft; a first synchronizer clutch operably coupled to the first gear set; a second synchronizer clutch operably coupled the second gear set; a third synchronizer clutch operably coupled to the third gear set; and a fourth synchronizer clutch operably coupled to the fourth gear set, wherein the first synchronizer clutch, the second synchronizer clutch, the third synchronizer clutch, and the fourth synchronizer clutch are operably coupled to, and coaxial to, the fifth rotatable shaft.

Provided herein is a continuously variable transmission having: a first rotatable shaft operably coupleable to a source of rotational power; a second rotatable shaft coaxial with the first rotatable shaft, the first rotatable shaft and the second rotatable shaft forming a main axis; a third rotatable shaft aligned coaxial to the main axis; a fourth rotatable shaft aligned coaxial to the third rotatable shaft; a fifth rotatable shaft arranged parallel to the main axis; a variator assembly having a first traction ring assembly and a second traction ring assembly in contact with a plurality of balls, wherein each ball of the plurality of balls has a tiltable axis of rotation, the variator assembly is coaxial with the main axis, the first traction ring assembly is operably coupled to the second rotatable shaft; a planetary gear set having a sun gear operably coupled to the second rotatable shaft, a planet carrier operably coupled to the first rotatable shaft, and a ring gear coupled to the second traction ring assembly; a first mode clutch coaxial with, and coupled to, the second rotatable shaft, the first-and-third mode clutch coupled to the third rotatable shaft; a second-and-reverse mode clutch coaxial with, and coupled to, the second rotatable shaft, the second-and-reverse mode clutch coupled to the fourth rotatable shaft; a first gear set operably coupled to the third rotatable shaft; a second gear set operably coupled to the fourth rotatable shaft; a first synchronizer clutch operably coupled to the first gear set; and a second synchronizer clutch operably coupled the second gear set, wherein the first synchronizer clutch and the second synchronizer clutch are operably coupled to, and coaxial to, the fifth rotatable shaft.

Provided herein is a continuously variable transmission including: a first rotatable shaft operably coupleable to a source of rotational power; a second rotatable shaft coaxial with the first rotatable shaft, the first rotatable shaft and the second rotatable shaft forming a main axis; a third rotatable shaft aligned coaxial to the main axis; a fourth rotatable shaft aligned coaxial to the third rotatable shaft; a fifth rotatable shaft arranged parallel to the main axis; a variator assembly having a first traction ring assembly and a second traction ring assembly in contact with a plurality of balls, wherein each ball of the plurality of balls has a tiltable axis of rotation, the variator assembly is coaxial with the main axis, the first traction ring assembly is operably coupled to the first rotatable shaft; a first mode clutch coaxial with, and coupled to, the second rotatable shaft, the first-and-third mode clutch coupled to the third rotatable shaft; a second-and-reverse mode clutch coaxial with, and coupled to, the second rotatable shaft, the second-and-reverse mode clutch coupled to the fourth rotatable shaft; a first gear set operably coupled to the third rotatable shaft; a second gear set operably coupled to the fourth rotatable shaft; and a first synchronizer clutch operably coupled to the second gear set, wherein the first gear set and the second synchronizer clutch are operably coupled to, and coaxial to, the fifth rotatable shaft.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the preferred embodiments are set forth with particularity in the appended claims. A better understanding of the features and advantages of the present embodiments will be obtained by reference to the following detailed description that sets forth illustrative embodiments, in which the principles of the preferred embodiments are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a schematic diagram of a powersplit variator.

FIG. 5 is a schematic diagram of a powersplit variator having a locking clutch.

FIG. 6 is a schematic diagram of another powersplit variator having a locking clutch.

FIG. 7 is a schematic diagram of yet another powersplit variator having a locking clutch.

FIG. 8 is a schematic diagram of a variator having a locking clutch coupled between a first traction ring assembly and a second traction ring assembly.

FIG. 9 is a schematic diagram of a planetary powersplit continuously variable transmission configured for a rear-wheel drive application.

FIG. 10 is a table depicting operating modes of the continuously variable transmissions depicted in FIG. 9.

FIG. 11 is a schematic diagram of another planetary powersplit continuously variable transmission configured for a rear-wheel drive application.

FIG. 12 is a table depicting operating modes of the continuously variable transmissions depicted in FIG. 11.

FIG. 13 is a schematic diagram of yet another planetary powersplit continuously variable transmission configured for a rear-wheel drive application.

FIG. 14 is a table depicting operating modes of the continuously variable transmissions depicted in FIG. 13.

FIG. 15 is a schematic diagram of yet another planetary powersplit continuously variable transmission configured for a rear-wheel drive application.

FIG. 16 is a table depicting operating modes of the continuously variable transmissions depicted in FIG. 15.

FIG. 17 is a schematic diagram of yet another planetary powersplit continuously variable transmission configured for a rear-wheel drive application.

FIG. 18 is a table depicting operating modes of the continuously variable transmission depicted in FIG. 17.

FIG. 19 is a schematic diagram of yet another planetary powersplit continuously variable transmission configured for a rear-wheel drive application.

FIG. 20 is a table depicting operating modes of the continuously variable transmission depicted in FIG. 19.

FIG. 21 is a schematic diagram of yet another planetary powersplit continuously variable transmission configured for a rear-wheel drive application.

FIG. 22 is a table depicting operating modes of the continuously variable transmission depicted in FIG. 21.

FIG. 23 is a schematic diagram of yet another planetary powersplit continuously variable transmission configured for a rear-wheel drive application.

FIG. 24 is a table depicting operating modes of the continuously variable transmission depicted in FIG. 23.

FIG. 25 is a schematic diagram of yet another planetary powersplit continuously variable transmission configured for a rear-wheel drive application.

FIG. 26 is a table depicting operating modes of the continuously variable transmission depicted in FIG. 25.

FIG. 27 is a schematic diagram of a powersplit variator having a stepped planet planetary gear set.

FIG. 28 is a schematic diagram of a powersplit variator having a geared differential.

FIG. 29 is a schematic diagram of a powersplit variator having dual sun planetary gear set.

FIG. 30 is a schematic diagram of a planetary powersplit variator having a number of couplings for transmitting power out of the variator.

### DETAILED DESCRIPTION

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments. Furthermore, embodiments includes several novel features, no single one of which is solely responsible for its desirable attributes or which is essential to practicing the embodiments described.

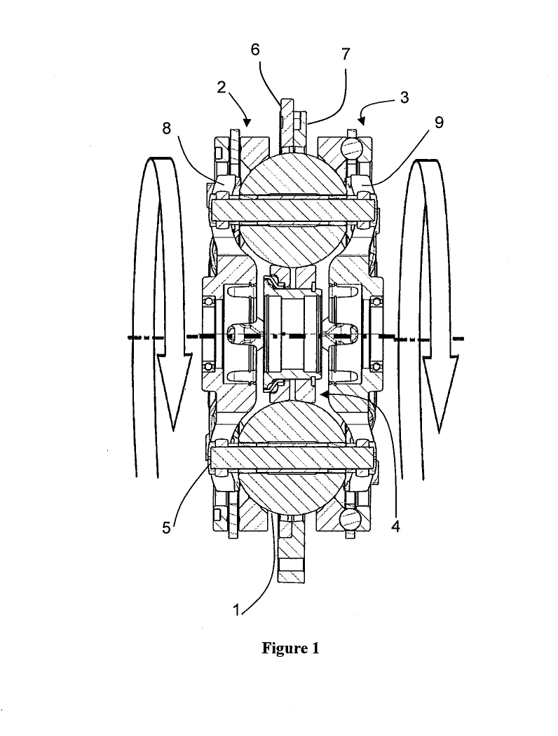

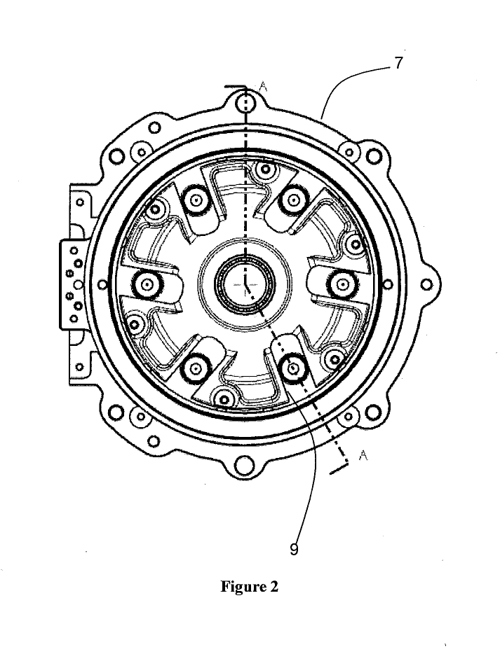

Provided herein are configurations of CVTs based on a ball type variators, also known as CVP, for continuously variable planetary. Basic concepts of a ball type Continuously Variable Transmissions are described in U.S. Pat. No. 8,469,856 and 8,870,711 incorporated herein by reference in their entirety. Such a CVT, adapted herein as described throughout this specification, comprises a number of balls (planets, spheres) 1, depending on the application, two ring (disc) assemblies with a conical surface in contact with the balls, an input traction ring 2, an output traction ring 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, but are slightly different.

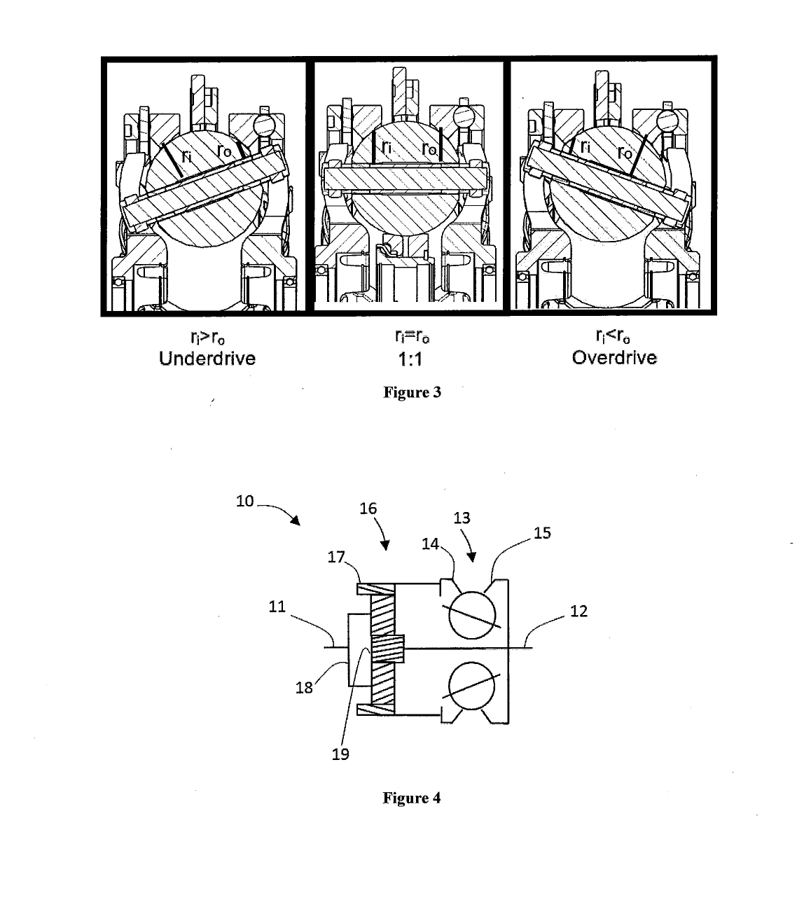

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments disclosed here are related to the control of a variator and/or a CVT using generally spherical planets each having a tiltable axis of rotation that are adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

As used here, the terms “operationally connected,” “operationally coupled”, “operationally linked”, “operably connected”, “operably coupled”, “operably linked,” “operably coupleable” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling take a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these are typically understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here operate in both tractive and frictional applications. For example, in the embodiment where a CVT is used for a bicycle application, the CVT operates at times as a friction drive and at other times as a traction drive, depending on the torque and speed conditions present during operation.

As used herein, “creep” or “slip” is the discrete local motion of a body relative to another and is exemplified by the relative velocities of rolling contact components such as the mechanism described herein. “Creep” is characterized by the slowing of the output because the transmitted force is stretching the fluid film in the direction of rolling. As used herein, the term “ratio droop” refers to the shift of the tilt angle of the ball axis of rotation (sometimes referred to as the ratio angle or gamma angle) due to a compliance of an associated control linkage in proportion to a control force that is in proportion to transmitted torque, wherein the compliance of the control linkage corresponds to a change in the skew angle of the ball axis of rotation. As used herein, the term “load droop” refers to any operating event that reduces the ratio of output speed to input speed as transmitted torque increases.

Typically, synchronizer mechanisms (referred to herein as “synchronizer clutch”) used in power transmissions include a dog clutch integrated with a speed-matching device such as a cone-clutch. During operation of the transmission, if the dog teeth of the dog clutch make contact with a gear, and the two parts are spinning at different speeds, the teeth will fail to engage and a loud grinding sound will be heard as they clatter together. For this reason, a synchronizer mechanism or synchronizer clutch is used, which consists of a cone clutch. Before the teeth engage, the cone clutch engages first, which brings the two rotating elements to the same speed using friction. Until synchronization occurs, the teeth are prevented from making contact. It should be appreciated that the exact design of the synchronizer clutch is within a designer's choice for satisfying packaging and performance requirements. A synchronizer clutch is optionally configured to be a two position clutch having an engaged position and a neutral (or free) position. A synchronizer clutch is optionally configured to be a three position clutch having a first engaged position, a second engaged position, and a neutral position. Embodiments disclosed herein use synchronizer clutches to enable the pre-selection of gear sets by a control system (not shown) for smooth transition between operating modes of the transmission. It should be appreciated that the powertrain configurations disclosed herein are optionally configured with other types of selectable torque transmitting devices including, and not limited to, wet clutches, dry clutches, dog clutches, and electromagnetic clutches, among others.

Referring now to FIG. 4, in some embodiments, a powersplit variator 10 includes a first rotatable shaft 11 adapted to receive power from a source of rotational power (not shown). The powersplit variator 10 includes a second rotatable shaft 12 adapted to transmit a rotational power out of the powersplit variator 10. For example, the second rotatable shaft 12 is adapted to couple to a multiple speed gear box (not shown) to provide multiple modes of operation. In some embodiments, the second rotatable shaft 12 is adapted to couple to a fixed ratio automatic transmission such as well-known multiple speed automatic transmissions or simplified versions thereof utilizing alternative friction plate clutches. It should be appreciated that other embodiments of powersplit variators are optionally configured to couple to the power transmission devices disclosed herein. In some embodiments, the powersplit variator 10 includes a variator 13. The variator 13 is optionally configured to be a variator similar to the variator depicted in FIGS. 1-3. The variator 13 is provided with a first traction ring assembly 15 and a second traction ring assembly 14. In some embodiments, the powersplit variator 10 includes a planetary gear set 16 having a ring gear 17, a planet carrier 18, and a sun gear 19. The ring gear 17 is operably coupled to the second traction ring assembly 14. The sun gear 19 is operably coupled to the second rotatable shaft 12. In some embodiments, the second rotatable shaft 12 is coupled to the first traction ring assembly 15. It should be noted that in some embodiments, the first rotatable shaft 11 is adapted to transmit power out of the powersplit variator 10 and the second rotatable shaft 12 is adapted to operably couple to a source of rotational power.

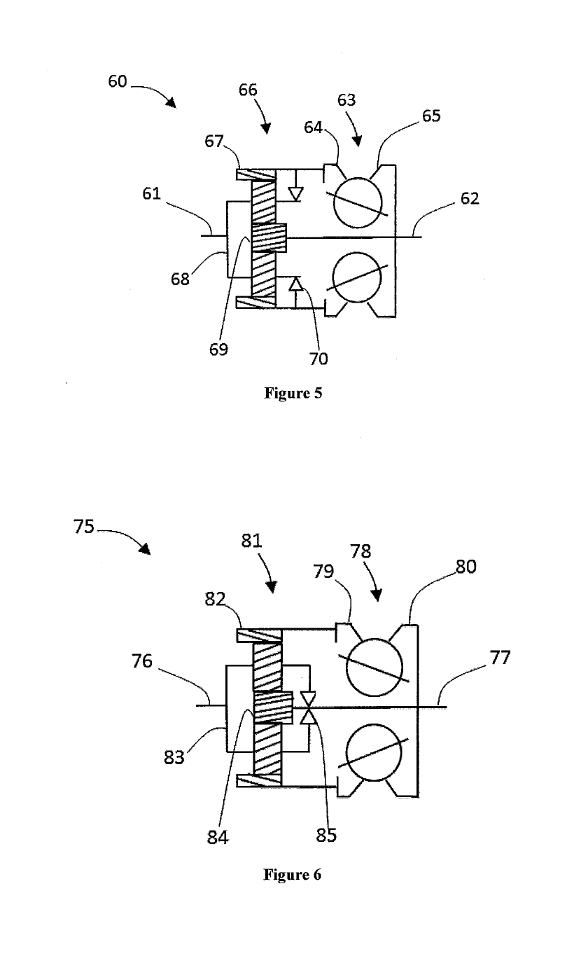

Referring now to FIG. 5, in some embodiments; a powersplit variator 60 includes a first rotatable shaft 61 adapted to receive power from a source of rotational power (not shown). The powersplit variator 60 includes a second rotatable shaft 62 adapted to transmit a rotational power out of the powersplit variator 60. For example, the second rotatable shaft 62 is adapted to couple to a multiple speed gear box (not shown) to provide multiple modes of operation. In some embodiments, the second rotatable shaft 62 is adapted to couple to a fixed ratio automatic transmission such as the General Motors 4L60/4L80 transmission, the Ford Motor Company 4R70, and other well-known multiple speed automatic transmissions or simplified versions thereof utilizing alternative friction plate clutches. It should be appreciated that embodiments of powersplit variators disclosed here are optionally configured to couple to any power transmission device. In some embodiments, the powersplit variator 60 includes a variator 63. The variator 63 is optionally configured to be a variator similar to the variator depicted in FIGS. 1-3. The variator 63 is provided with a first traction ring assembly 65 and a second traction ring assembly 64. In some embodiments, the powersplit variator 60 includes a planetary gear set 66 having a ring gear 67, a planet carrier 68, and a sun gear 69. The ring gear 67 is operably coupled to the second traction ring assembly 64. The sun gear 69 is operably coupled to the second rotatable shaft 62. In some embodiments, the second rotatable shaft 62 is coupled to the first traction ring assembly 65. In some embodiments, the powersplit variator 60 includes a locking clutch 70 operably coupled to the ring gear 67 and the planet carrier 68. It should be noted that in some embodiments, the first rotatable shaft 61 is adapted to transmit power out of the powersplit variator 60 and the second rotatable shaft 62 is adapted to operably couple to a source of rotational power.

Referring now to FIG. 6, in some embodiments; a powersplit variator 75 includes a first rotatable shaft 76 adapted to receive power from a source of rotational power (not shown). The powersplit variator 75 includes a second rotatable shaft 77 configured to transmit an output power from the powersplit variator 75. The powersplit variator 75 includes a variator 78 having a first traction ring assembly 80 and a second traction ring assembly 79. The powersplit variator 75 includes a planetary gear set 81 having a ring gear 82, a planet carrier 83, and a sun gear 84. In some embodiments, the ring gear 82 is operably coupled to the second traction ring assembly 79. The sun gear 84 is coupled to the second rotatable shaft 77. The first traction ring assembly 80 is coupled to the second rotatable shaft 77. In some embodiments, the powersplit variator 75 is provided with a locking clutch 85 coupled to the planet carrier 83 and the sun gear 84. It should be noted that in some embodiments, the first rotatable shaft 76 is adapted to transmit power out of the powersplit variator 75 and the second rotatable shaft 77 is adapted to operably couple to a source of rotational power.

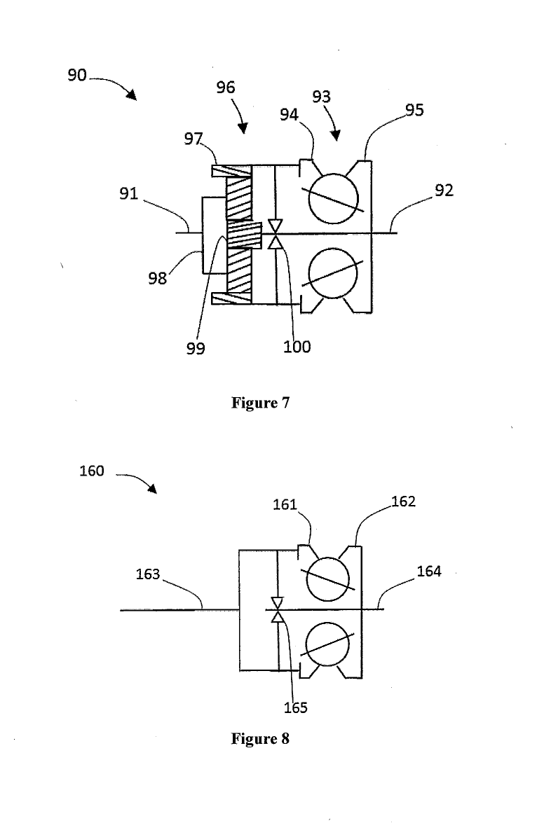

Referring now to FIG. 7, in some embodiments; a powersplit variator 90 includes a first rotatable shaft 91 adapted to receive power from a source of rotational power (not shown). The powersplit variator 90 includes a second rotatable shaft 92 configured to transmit an output power from the powersplit variator 90. The powersplit variator 90 includes a variator 93 having a first traction ring assembly 95 and a second traction ring assembly 94. The powersplit variator 90 includes a planetary gear set 96 having a ring gear 97, a planet carrier 98, and a sun gear 99. In some embodiments, the ring gear 97 is operably coupled to the second traction ring assembly 94. The sun gear 99 is coupled to the second rotatable shaft 92. The first traction ring assembly 95 is coupled to the second rotatable shaft 92. In some embodiments, the powersplit variator 90 is provided with a locking clutch 100 coupled to the ring gear 97 and the sun gear 99. It should be noted that in some embodiments, the first rotatable shaft 91 is adapted to transmit power out of the powersplit variator 90 and the second rotatable shaft 92 is adapted to operably couple to a source of rotational power.

Referring now to FIG. 8, in some embodiments, a variator 160 is provided with a first traction ring assembly 161 and a second traction ring assembly 162 in contact with a plurality of balls. The variator 160 is similar to the variator depicted in FIGS. 1-3. The first traction ring assembly 161 is coupled to a first rotatable shaft 163. In some embodiments, the first rotatable shaft 163 is adapted to operably couple to a source of rotational power. In other embodiments, the first rotatable shaft 163 is adapted to transmit a power out of the variator 160. The second traction ring assembly 162 is operably coupled to a second rotatable shaft 164. In some embodiments, the second rotatable shaft 164 is adapted to transmit a power out of the variator 160. In other embodiments, the second rotatable shaft 164 is adapted to operably couple to a source of rotational power. The variator 160 is optionally provided with a locking clutch 165 coupled to the first traction ring assembly 161 and the second rotatable shaft 164. The locking clutch 165 is configured to selectively engage the first traction ring assembly 161 and the second rotatable shaft 164 to thereby transmit power from the first rotatable shaft 163 to the second rotatable shaft 164.

It should be appreciated that the locking clutch 25, the locking clutch 56, the locking clutch 70, the locking clutch 85, and the locking clutch 100 disclosed herein are optionally configured as wet clutch, dry clutches, synchronizer clutches, one-way clutches, or mechanical diodes. In some embodiments, the continuously variable transmissions disclosed herein are optionally configured to include powersplit variator devices such as the devices disclosed in FIGS. 4-8, and described with related control methods in U.S. Patent Application No. 62/333,632, which is hereby incorporated by reference.

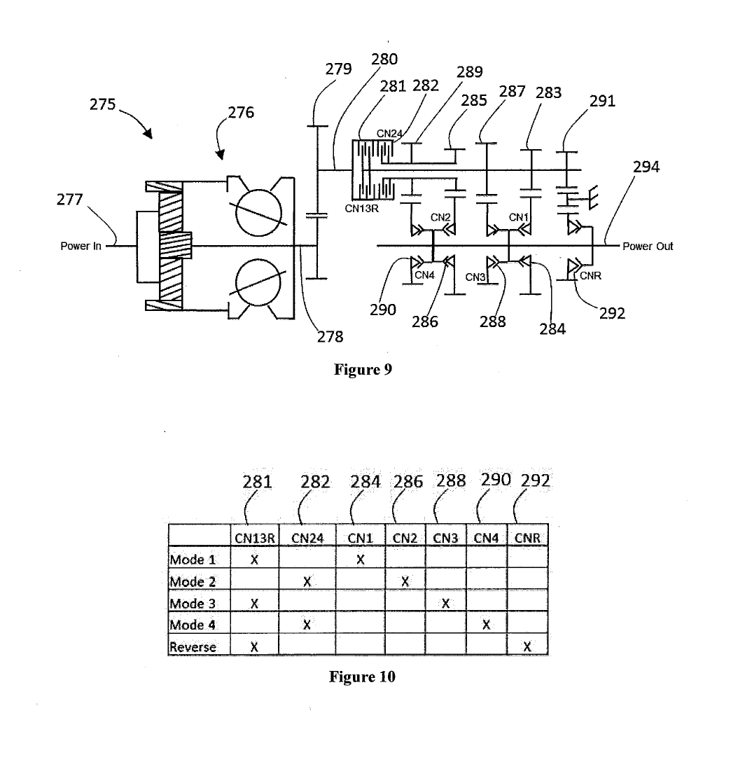

Turning now to FIG. 9, in some embodiments; a continuously variable transmission (CVT) 275 includes a powersplit variator 276 having a first rotatable shaft 277 and a second rotatable shaft 278. In some embodiments, the powersplit variator 276 is configured such as the variators described in FIGS. 1-8. The first rotatable shaft 277 is configured to operably couple to a source of rotational power (not shown). The second rotatable shaft 278 is coupled to a transfer coupling 279. In some embodiments, the transfer coupling 279 is a meshing gear set. In other embodiments, the transfer coupling 279 is optionally configured as a chain-and-sprocket coupling, a belt-and-pulley coupling, or other device configured to transmit rotational power between two parallel shafts. The transfer coupling 279 is coupled to a third rotatable shaft 280. The third rotatable shaft 280 is arranged parallel to the second rotatable shaft 278. The third rotatable shaft 280 is operably coupled to a first-and-third mode clutch 281. In some embodiments, the third rotatable shaft 280 is operably coupled to a second-and-fourth mode clutch 282.

Still referring to FIG. 9, in some embodiments; the CVT 275 includes a first gear set 283 operably coupled to the first-and-third mode clutch 281. The first gear set 283 is coupled to a first synchronizer clutch 284. The CVT 275 includes a second gear set 285 operably coupled to the second-and-fourth mode clutch 282. The second gear set 285 is coupled to a second synchronizer clutch 286. The CVT 275 includes a third gear set 287 operably coupled to the first-and-third mode clutch 281. The third gear set 287 is coupled to a third synchronizer clutch 288. The CVT 275 includes a fourth gear set 289 operably coupled to the second-and-fourth mode clutch 282. The fourth gear set 289 is coupled to a fourth synchronizer clutch 290. The CVT 275 includes a reverse gear set 291 operably coupled to the first-and-third mode clutch 281. The reverse gear set 291 is coupled to a reverse synchronizer clutch 292. The first synchronizer clutch 284, the second synchronizer clutch 286, the third synchronizer clutch 288, the fourth synchronizer clutch 290, and the reverse synchronizer clutch 292 are operably coupled to a fourth rotatable shaft 294. The fourth rotatable shaft 294 is arranged coaxial to the second rotatable shaft 278. The fourth rotatable shaft 294 is configured to transmit an output power.

Referring now to FIG. 10, during operation of the CVT 275, multiple modes of operation are achieved through engagement of the various clutching devices to provide modes corresponding to overlapping ranges of speed and torque. Typically, the first mode of operation corresponds to a launch mode of a vehicle from a stop. The subsequent modes engaged correspond to higher speed ranges. Likewise, the reverse mode of operation corresponds to a reverse direction of a vehicle equipped with the CVT 275. The table depicted in FIG. 10, lists the modes of operation for the CVT 275 and indicates with an “x” the corresponding clutch engagement. For mode 1 operation, the first-and-third mode clutch 281 and the first synchronizer clutch 284 are engaged. For mode 2 operation, the second-and-fourth mode clutch 282 and the second synchronizer clutch 286 are engaged. For mode 3 operation, the first-and-third mode clutch 281 and the third synchronizer clutch 288 are engaged. For mode 4 operation, the second-and-fourth mode clutch 282 and the fourth synchronizer clutch 290 are engaged. For reverse mode operation, the first-and-third mode clutch 281 and the reverse synchronizer clutch 292 are engaged. In some embodiments, the powersplit variator 276 is provided with a locking clutch such as the powersplit variators depicted in FIGS. 5-8. In these embodiments, the locking clutch is optionally configured to selectively engage during operation to provide a fixed ratio operating mode as an optional gear in any of the four modes of operation depicted in FIG. 9. During fixed ratio operating modes, power is transmitting through fixed gear ratios and the variator operates at a 1:1 speed ratio without transmitting any power. For example, engagement of the locking clutch in mode 1 provides a fixed ratio for vehicle launch from a stop. The locking clutch can be disengaged when a desired vehicle speed is reach and the vehicle continues to operate in mode 1 with power transmitted through the variator. The locking clutch can be. engaged during mode 2, mode 3, mode 4, or reverse operation to transmit power through fixed gear ratios and effectively bypass the variator.

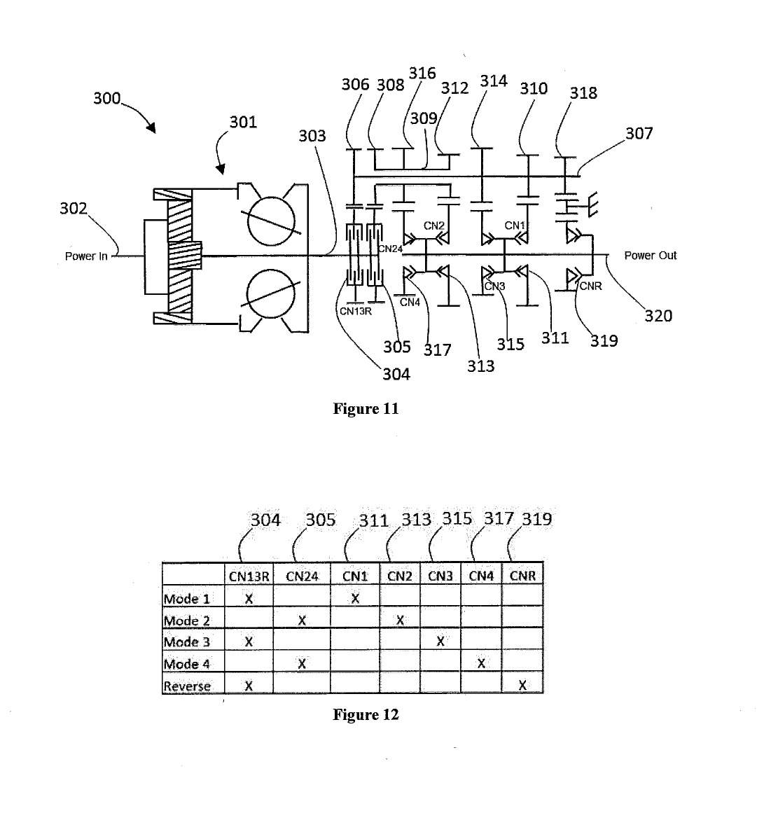

Referring now to FIG. 11, in some embodiments; a continuously variable transmission (CVT) 300 includes a powersplit variator 301 having a first rotatable shaft 302 and a second rotatable shaft 303. In some embodiments, the powersplit variator 301 is configured such as the variators described in FIGS. 1-8. The first rotatable shaft 302 is configured to operably couple to a source of rotational power (not shown). The second rotatable shaft 303 is coupled a first-and-third mode clutch 304. In some embodiments, the second rotatable shaft 303 is coupled to a second-and-fourth mode clutch 305. The first-and-third mode clutch 304 is coupled to a first-and-third-mode gear set 306. The first-and-third mode gear set 306 is coupled to a third rotatable shaft 307. The second-and-fourth mode clutch 305 is coupled to a second-and-fourth mode gear set 308 is coupled to a fourth rotatable shaft 309. In some embodiments, the fourth rotatable shaft 309 is optionally configured as a hollow shaft through which the third rotatable shaft 307 is positioned. The third rotatable shaft 307 and the fourth rotatable shaft 309 are coaxial. The third rotatable shaft 307 and the fourth rotatable shaft 309 are parallel to the second rotatable shaft 303.

Still referring to FIG. 11, in some embodiments; the CVT 300 includes a first gear set 310 operably coupled to the third rotatable shaft 307. The first gear set 310 is coupled to a first synchronizer clutch 311. The CVT 300 includes a second gear set 312 operably coupled to the fourth rotatable shaft 309. The second gear set 312 is coupled to a second synchronizer clutch 313. The CVT 300 includes a third gear set 314 operably coupled to the third rotatable shaft 307. The third gear set 314 is coupled to a third synchronizer clutch 315. The CVT 300 includes a fourth gear set 316 operably coupled to the fourth rotatable shaft 309. The fourth gear set 316 is coupled to a fourth synchronizer clutch 317. The CVT 300 includes a reverse gear set 318 operably coupled to the third rotatable shaft 307. The reverse gear set 318 is coupled to a reverse synchronizer clutch 319. The first synchronizer clutch 311, the second synchronizer clutch 313, the third synchronizer clutch 315, the fourth synchronizer clutch 317, and the reverse synchronizer clutch 319 are operably coupled to a fifth rotatable shaft 320. The fifth rotatable shaft 320 is arranged coaxial to the second rotatable shaft 303. The fifth rotatable shaft 320 is configured to transmit an output power.

Referring now to FIG. 12, during operation of the CVT 300, multiple modes of operation are achieved through engagement of the various clutching devices to provide modes corresponding to overlapping ranges of speed and torque. Typically, the first mode of operation corresponds to a launch mode of a vehicle from a stop. The subsequent modes engaged correspond to higher speed ranges. Likewise, the reverse mode of operation corresponds to a reverse direction of a vehicle equipped with the CVT 300. The table depicted in FIG. 12, lists the modes of operation for the CVT 300 and indicates with an “x” the corresponding clutch engagement. For mode 1 operation, the first-and-third mode clutch 304 and the first synchronizer clutch 311 are engaged. For mode 2 operation, the second-and-fourth mode clutch 305 and the second synchronizer clutch 313 are engaged. For mode 3 operation, the first-and-third mode clutch 304 and the third synchronizer clutch 315 are engaged. For mode 4 operation, the second-and-fourth mode clutch 305 and the fourth synchronizer clutch 317 are engaged. For reverse mode operation, the first-and-third mode clutch 304 and the reverse synchronizer clutch 319 are engaged. In some embodiments, the powersplit variator 301 is provided with a locking clutch such as the powersplit variators depicted in FIGS. 5-8. In these embodiments, the locking clutch is optionally configured to selectively engage during operation to provide a fixed ratio operating mode as an optional gear in any of the four modes of operation depicted in FIG. 11. During fixed ratio operating modes, power is transmitting through fixed gear ratios and the variator operates at a 1:1 speed ratio without transmitting any power. For example, engagement of the locking clutch in mode 1 provides a fixed ratio for vehicle launch from a stop. The locking clutch can be disengaged when a desired vehicle speed is reach and the vehicle continues to operate in mode 1 with power transmitted through the variator. The locking clutch can be engaged during mode 2, mode 3, mode 4, or reverse operation to transmit power through fixed gear ratios and effectively bypass the variator.

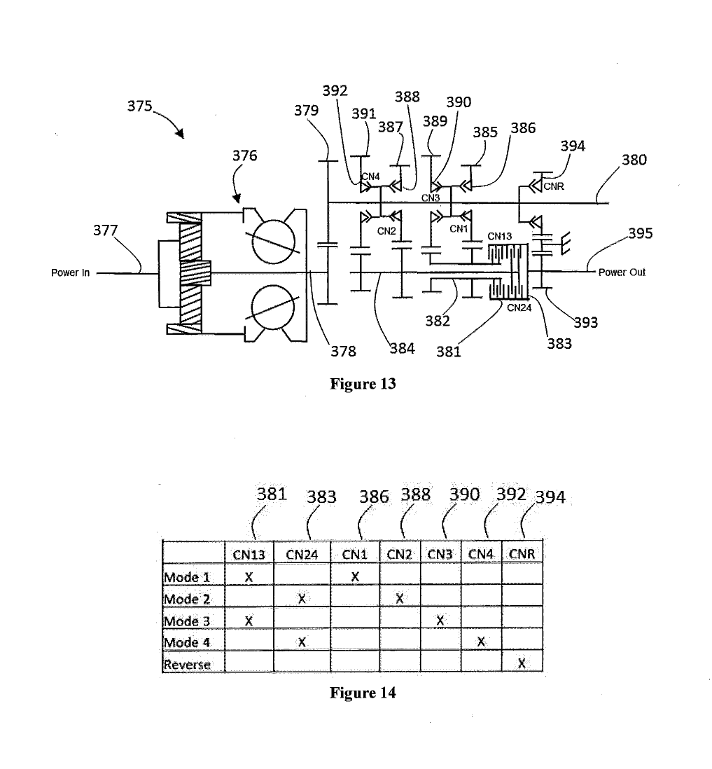

Referring now to FIG. 13, in some embodiments; a continuously variable transmission (CVT) 375 includes a powersplit variator 376 having a first rotatable shaft 377 and a second rotatable shaft 378. In some embodiments, the powersplit variator 376 is configured such as the variators described in FIGS. 1-8. The first rotatable shaft 377 is configured to operably couple to a source of rotational power (not shown). The second rotatable shaft 378 is coupled to a transfer coupling 379. In some embodiments, the transfer coupling 379 is a meshing gear set. In other embodiments, the transfer coupling 379 is optionally configured as a chain-and-sprocket coupling, a belt-and-pulley coupling, or other device configured to transmit rotational power between two or more parallel shafts. The transfer coupling 379 is coupled to a third rotatable shaft 380. The third rotatable shaft 380 is arranged parallel to the second rotatable shaft 378. In some embodiments, the CVT 375 includes a first-and-third mode clutch 381 operably coupled to a fourth rotatable shaft 382. The fourth rotatable shaft 382 is arranged parallel to the third rotatable shaft 380. In some embodiments, the fourth rotatable shaft 382 is configured as a hollow shaft. In some embodiments, the CVT 375 includes a second-and-fourth mode clutch 383 operably coupled to a fifth rotatable shaft 384. The fifth rotatable shaft 384 is coaxial with the fourth rotatable shaft 382. The fifth rotatable shaft 384 is parallel to the third rotatable shaft 380. The fourth rotatable shaft 382 and the fifth rotatable shaft 384 are coaxial with the second rotatable shaft 378.

Still referring to FIG. 13, in some embodiments; the CVT 375 includes a first gear set 385 operably coupled to the first-and-third mode clutch 381. The first gear set 385 is coupled to a first synchronizer clutch 386. The CVT 375 includes a second gear set 387 operably coupled to the second-and-fourth mode clutch 383. The second gear set 387 is coupled to a second synchronizer clutch 388. The CVT 375 includes a third gear set 389 operably coupled to the first-and-third mode clutch 381. The third gear set 389 is coupled to a third synchronizer clutch 390. The CVT 375 includes a fourth gear set 391 operably coupled to the second-and-fourth mode clutch 383. The fourth gear set 391 is coupled to a fourth synchronizer clutch 392. The CVT 375 includes a reverse gear set 393 operably coupled to a reverse synchronizer clutch 394. The reverse synchronizer clutch 394 is coupled to the third rotatable shaft 380. The first synchronizer clutch 386, the second synchronizer clutch 388, the third synchronizer clutch 390, the fourth synchronizer clutch 392, and the reverse synchronizer clutch 394 are operably coupled to the third rotatable shaft 380. In some embodiments, the CVT 375 includes a sixth rotatable shaft 395 arranged coaxial to the second rotatable shaft 378. The sixth rotatable shaft 395 is arranged coaxial with the fourth rotatable shaft 382 and the fifth rotatable shaft 384. The sixth rotatable shaft 395 is arranged parallel to the third rotatable shaft 380. The sixth rotatable shaft 395 is coupled to the first-and-third mode clutch 381 and the second-and-fourth mode clutch 383. The sixth rotatable shaft 395 is configured to transmit an output power.

Referring now to FIG. 14, during operation of the CVT 375, multiple modes of operation are achieved through engagement of the various clutching devices to provide modes corresponding to overlapping ranges of speed and torque. Typically, the first mode of operation corresponds to a launch mode of a vehicle from a stop. The subsequent modes engaged correspond to higher speed ranges. Likewise, the reverse mode of operation corresponds to a reverse direction of a vehicle equipped with the CVT 375. The table depicted in FIG. 14, lists the modes of operation for the CVT 375 and indicates with an “x” the corresponding clutch engagement. For mode 1 operation, the first-and-third mode clutch 381 and the first synchronizer clutch 386 are engaged. For mode 2 operation, the second-and-fourth mode clutch 383 and the second synchronizer clutch 388 are engaged. For mode 3 operation, the first-and-third mode clutch 381 and the third synchronizer clutch 390 are engaged. For mode 4 operation, the second-and-fourth mode clutch 383 and the fourth synchronizer clutch 392 are engaged. For reverse mode operation, the reverse synchronizer clutch 392 is engaged. In some embodiments, the powersplit variator 376 is provided with a locking clutch such as the powersplit variators depicted in FIGS. 5-8. In these embodiments, the locking clutch is optionally configured to selectively engage during operation to provide a fixed ratio operating mode as an optional gear in any of the four modes of operation depicted in FIG. 13. During fixed ratio operating modes, power is transmitting through fixed gear ratios and the variator operates at a 1:1 speed ratio without transmitting any power. For example, engagement of the locking clutch in mode 1 provides a fixed ratio for vehicle launch from a stop. The locking clutch can be disengaged when a desired vehicle speed is reach and the vehicle continues to operate in mode 1 with power transmitted through the variator. The locking clutch can be engaged during mode 2, mode 3, mode 4, or reverse operation to transmit power through fixed gear ratios and effectively bypass the variator.

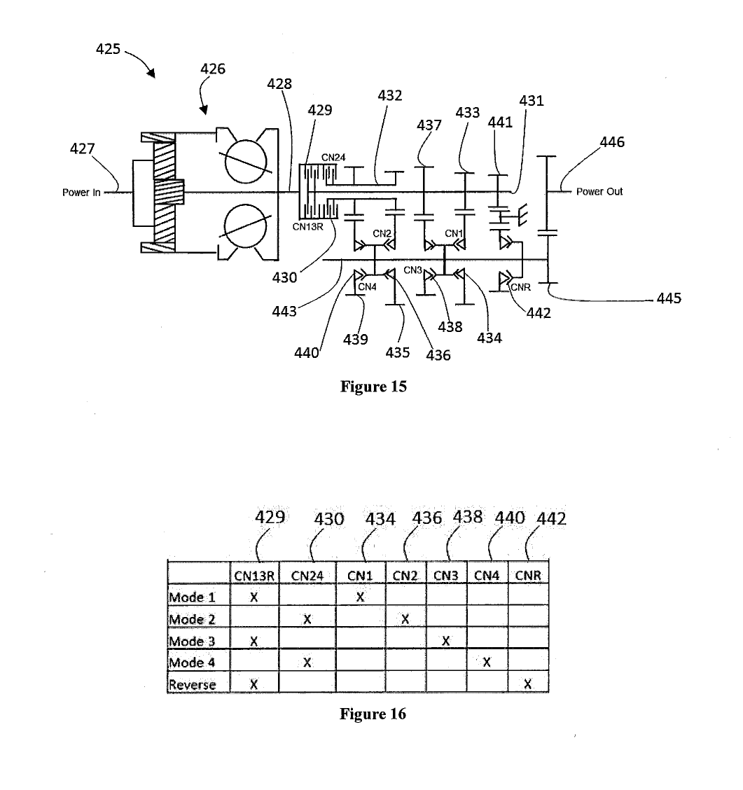

Referring now to FIG. 15, in some embodiments; a continuously variable transmission (CVT) 425 includes a powersplit variator 426 having a first rotatable shaft 427 and a second rotatable shaft 428. In some embodiments, the powersplit variator 426 is configured such as the variators described in FIGS. 1-8. The first rotatable shaft 427 is configured to operably couple to a source of rotational power (not shown). The second rotatable shaft 428 is coupled to a first-and-third mode clutch 429 and a second-and-fourth mode clutch 430. In some embodiments, the CVT 425 includes a third rotatable shaft 431 arranged coaxial to the second rotatable shaft 428. The third rotatable shaft 431 is operably coupled to the first-and-third mode clutch 429. In some embodiments, the CVT 425 includes a fourth rotatable shaft 432 arranged coaxial to the third rotatable shaft 431. The fourth rotatable shaft 432 is configured as a hollow shaft through which the third rotatable shaft 431 is positioned. The second-and-fourth mode clutch 430 is coupled to the fourth rotatable shaft 432.

Still referring to FIG. 15, in some embodiments; the CVT 425 includes a first gear set 433 operably coupled to the first-and-third mode clutch 429. The first gear set 433 is coupled to a first synchronizer clutch 434. The CVT 425 includes a second gear set 435 operably coupled to the second-and-fourth mode clutch 430. The second gear set 435 is coupled to a second synchronizer clutch 436. The CVT 425 includes a third gear set 437 operably coupled to the first-and-third mode clutch 429. The third gear set 437 is coupled to a third synchronizer clutch 438. The CVT 425 includes a fourth gear set 439 operably coupled to the second-and-fourth mode clutch 430. The fourth gear set 439 is coupled to a fourth synchronizer clutch 440. The CVT 425 includes a reverse gear set 441 operably coupled to a reverse synchronizer clutch 442. The first synchronizer clutch 434, the second synchronizer clutch 436, the third synchronizer clutch 438, the fourth synchronizer clutch 440, and the reverse synchronizer clutch 442 are coupled to a fifth rotatable shaft 443. The fifth rotatable shaft 443 is arranged parallel to the third rotatable shaft 431. In some embodiments, the CVT 425 includes a final drive gear set 445 coupled to a sixth rotatable shaft 446. The sixth rotatable shaft 446 is arranged coaxial to the third rotatable shaft 431. The sixth rotatable shaft 446 is configured to transmit an output power.

Referring now to FIG. 16, during operation of the CVT 425, multiple modes of operation are achieved through engagement of the various clutching devices to provide modes corresponding to overlapping ranges of speed and torque. Typically, the first mode of operation corresponds to a launch mode of a vehicle from a stop. The subsequent modes engaged correspond to higher speed ranges. Likewise, the reverse mode of operation corresponds to a reverse direction of a vehicle equipped with the CVT 425. The table depicted in FIG. 16, lists the modes of operation for the CVT 425 and indicates with an “x” the corresponding clutch engagement. For mode 1 operation, the first-and-third mode clutch 429 and the first synchronizer clutch 434 are engaged. For mode 2 operation, the second-and-fourth mode clutch 430 and the second synchronizer clutch 436 are engaged. For mode 3 operation, the first-and-third mode clutch 429 and the third synchronizer clutch 438 are engaged. For mode 4 operation, the second-and-fourth mode clutch 430 and the fourth synchronizer clutch 440 are engaged. For reverse mode operation, the first-and-third mode clutch 429 and the reverse synchronizer clutch 442 are engaged. In some embodiments, the powersplit variator 426 is provided with a locking clutch such as the powersplit variators depicted in FIGS. 5-8. In these embodiments, the locking clutch is optionally configured to selectively engage during operation to provide a fixed ratio operating mode as an optional gear in any of the four modes of operation depicted in FIG. 15. During fixed ratio operating modes, power is transmitting through fixed gear ratios and the variator operates at a 1:1 speed ratio without transmitting any power. For example, engagement of the locking clutch in mode 1 provides a fixed ratio for vehicle launch from a stop. The locking clutch can be disengaged when a desired vehicle speed is reach and the vehicle continues to operate in mode 1 with power transmitted through the variator. The locking clutch can be engaged during mode 2, mode 3, mode 4, or reverse operation to transmit power through fixed gear ratios and effectively bypass the variator.

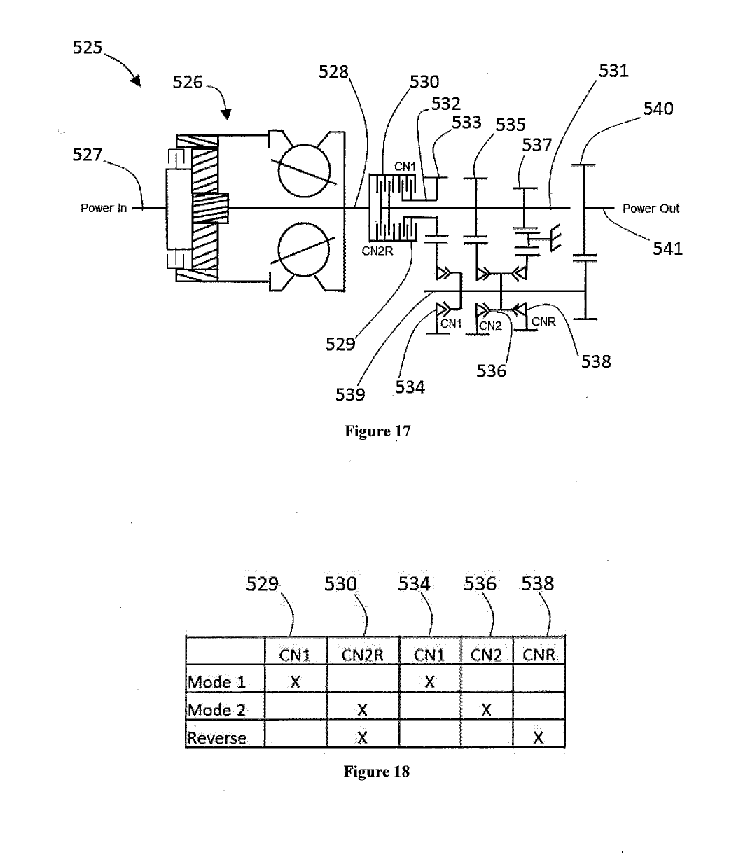

Still referring to FIG. 17, in some embodiments; the CVT 525 includes a first gear set 533 operably coupled to the first mode clutch 529. The first gear set 533 is coupled to a first synchronizer clutch 534. The CVT 525 includes a second gear set 535 operably coupled to the second-and-reverse mode clutch 530. The second gear set 535 is coupled to a second synchronizer clutch 536. The CVT 525 includes a reverse gear set 537 operably coupled to a reverse synchronizer clutch 538. The first synchronizer clutch 534, the second synchronizer clutch 536, and the reverse synchronizer clutch 538 are coupled to a fifth rotatable shaft 539. The fifth rotatable shaft 539 is arranged parallel to the third rotatable shaft 531. In some embodiments, the CVT 525 includes a final drive gear set 540 coupled to a sixth rotatable shaft 541. The sixth rotatable shaft 540 is arranged coaxial to the third rotatable shaft 531. The sixth rotatable shaft 540 is configured to transmit an output power.

Referring now to FIG. 18, during operation of the CVT 525, multiple modes of operation are achieved through engagement of the various clutching devices to provide modes corresponding to overlapping ranges of speed and torque. Typically, the first mode of operation corresponds to a launch mode of a vehicle from a stop. The subsequent modes engaged correspond to higher speed ranges. Likewise, the reverse mode of operation corresponds to a reverse direction of a vehicle equipped with the CVT 525. The table depicted in FIG. 18, lists the modes of operation for the CVT 525 and indicates with an “x” the corresponding clutch engagement. For mode 1 operation, the first mode clutch 529 and the first synchronizer clutch 534 are engaged. For mode 2 operation, the second-and-reverse mode clutch 530 and the second synchronizer clutch 536 are engaged. For reverse mode operation, the second-and-reverse mode clutch 529 and the reverse synchronizer clutch 538 are engaged. In some embodiments, the powersplit variator 526 is provided with a locking clutch such as the powersplit variators depicted in FIGS. 5-8. In these embodiments, the locking clutch is optionally configured to selectively engage during operation to provide a fixed ratio operating mode as an optional gear in any of the three modes of operation depicted in FIG. 18. During fixed ratio operating modes, power is transmitting through fixed gear ratios and the variator operates at a 1:1 speed ratio without transmitting any power. For example, engagement of the locking clutch in mode 1 provides a fixed ratio for vehicle launch from a stop. The locking clutch can be disengaged when a desired vehicle speed is reach and the vehicle continues to operate in mode 1 with power transmitted through the variator. The locking clutch can be engaged during mode 2, or reverse operation to transmit power through fixed gear ratios and effectively bypass the variator.

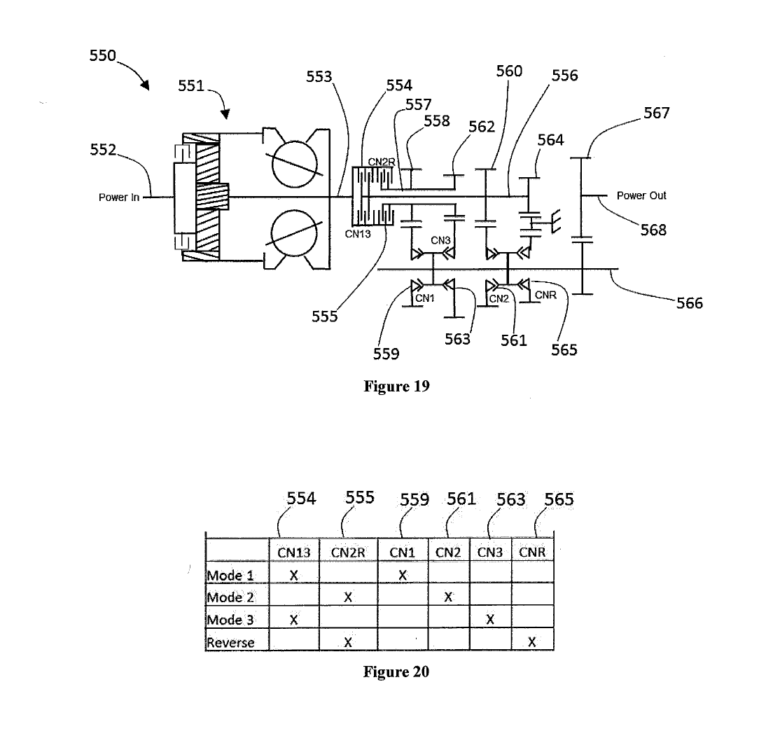

Referring now to FIG. 19, in some embodiments; a continuously variable transmission (CVT) 550 includes a powersplit variator 551 having a first rotatable shaft 552 and a second rotatable shaft 553. In some embodiments, the powersplit variator 551 is configured such as the variators described in FIGS. 1-8. The first rotatable shaft 552 is configured to operably couple to a source of rotational power (not shown). The second rotatable shaft 553 is coupled to a first-and-third mode clutch 554 and a second-and-reverse mode clutch 555. In some embodiments, the CVT 550 includes a third rotatable shaft 556 arranged coaxial to the second rotatable shaft 554. The third rotatable shaft 556 is operably coupled to the first-and-third mode clutch 554. In some embodiments, the CVT 550 includes a fourth rotatable shaft 557 arranged coaxial to the third rotatable shaft 556. The fourth rotatable shaft 557 is configured as a hollow shaft through which the third rotatable shaft 556 is positioned. The second-and-reverse mode clutch 555 is coupled to the fourth rotatable shaft 557.

Still referring to FIG. 19, in some embodiments; the CVT 550 includes a first gear set 558 operably coupled to the first-and-third mode clutch 554. The first gear set 558 is coupled to a first synchronizer clutch 559. The CVT 550 includes a second gear set 560 operably coupled to the second-and-reverse mode clutch 555. The second gear set 560 is coupled to a second synchronizer clutch 561. The CVT 550 includes a third gear set 562 operably coupled to the first-and-third mode clutch 554. The third gear set 562 is operably coupled to a third synchronizer clutch 563. In some embodiments, the CVT 550 includes a reverse gear set 564 operably coupled to the second-and-reverse mode clutch 555. The reverse gear set 564 is operably coupled to a reverse synchronizer clutch 565. The first synchronizer clutch 559, the second synchronizer clutch 561, the third synchronizer clutch 563, and the reverse synchronizer clutch 565 are coupled to a fifth rotatable shaft 566. The fifth rotatable shaft 566 is arranged parallel to the third rotatable shaft 556. In some embodiments, the CVT 550 includes a final drive gear set 567 coupled to a sixth rotatable shaft 568. The sixth rotatable shaft 568 is arranged coaxial to the third rotatable shaft 556. The sixth rotatable shaft 568 is configured to transmit an output power.

Referring now to FIG. 20, during operation of the CVT 550, multiple modes of operation are achieved through engagement of the various clutching devices to provide modes corresponding to overlapping ranges of speed and torque. Typically, the first mode of operation corresponds to a launch mode of a vehicle from a stop. The subsequent modes engaged correspond to higher speed ranges. Likewise, the reverse mode of operation corresponds to a reverse direction of a vehicle equipped with the CVT 550. The table depicted in FIG. 20, lists the modes of operation for the CVT 550 and indicates with an “x” the corresponding clutch engagement. For mode 1 operation, the first-and-third mode clutch 554 and the first synchronizer clutch 559 are engaged. For mode 2 operation, the second-and-reverse mode clutch 555 and the second synchronizer clutch 561 are engaged. For mode 3 operation, the first-and-third mode clutch 554 and the third synchronizer clutch 563 are engaged. For reverse mode operation, the second-and-reverse mode clutch 555 and the reverse synchronizer clutch 565 are engaged. In some embodiments, the powersplit variator 551 is provided with a locking clutch such as the powersplit variators depicted in FIGS. 5-8. In these embodiments, the locking clutch is optionally configured to selectively engage during operation to provide a fixed ratio operating mode as an optional gear in any of the four modes of operation depicted in FIG. 20. During fixed ratio operating modes, power is transmitting through fixed gear ratios and the variator operates at a 1:1 speed ratio without transmitting any power. For example, engagement of the locking clutch in mode 1 provides a fixed ratio for vehicle launch from a stop. The locking clutch can be disengaged when a desired vehicle speed is reach and the vehicle continues to operate in mode 1 with power transmitted through the variator. The locking clutch can be engaged during mode 2, mode 3, or reverse operation to transmit power through fixed gear ratios and effectively bypass the variator.

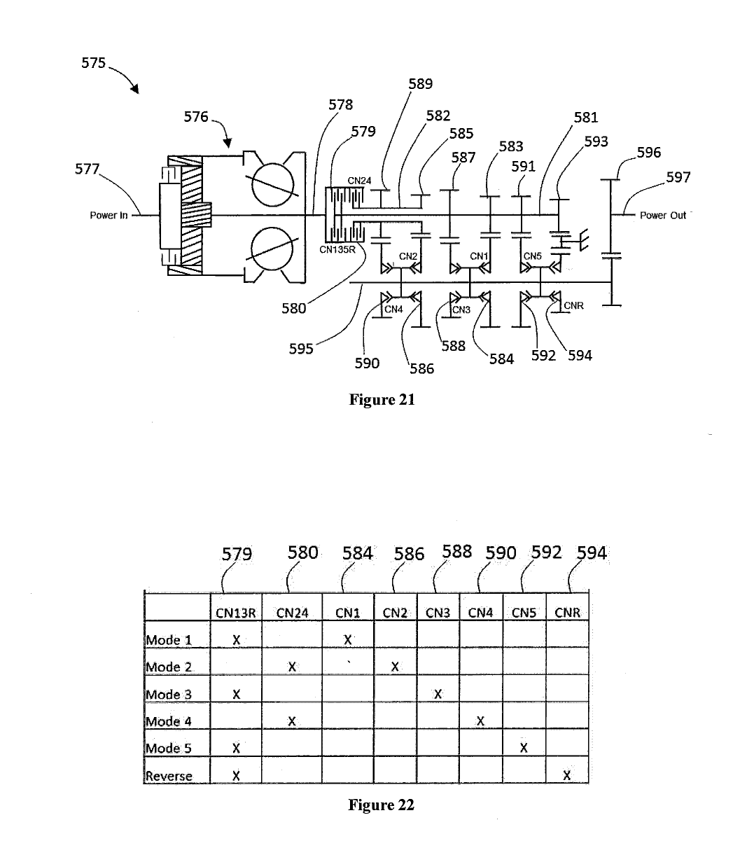

Referring now to FIG. 21, in some embodiments; a continuously variable transmission (CVT) 575 includes a powersplit variator 576 having a first rotatable shaft 577 and a second rotatable shaft 578. In some embodiments, the powersplit variator 576 is configured such as the variators described in FIGS. 1-8. The first rotatable shaft 577 is configured to operably couple to a source of rotational power (not shown). The second rotatable shaft 578 is coupled to a first-and-third mode clutch 579 and a second-and-fourth mode clutch 580. In some embodiments, the CVT 575 includes a third rotatable shaft 581 arranged coaxial to the second rotatable shaft 578. The third rotatable shaft 581 is operably coupled to the first-and-third mode clutch 579. In some embodiments, the CVT 575 includes a fourth rotatable shaft 582 arranged coaxial to the third rotatable shaft 581. The fourth rotatable shaft 582 is configured as a hollow shaft through which the third rotatable shaft 581 is positioned. The second-and-fourth mode clutch 580 is coupled to the fourth rotatable shaft 582.

Still referring to FIG. 21, in some embodiments; the CVT 575 includes a first gear set 583 operably coupled to the first-and-third mode clutch 579. The first gear set 583 is coupled to a first synchronizer clutch 584. The CVT 575 includes a second gear set 585 operably coupled to the second-and-fourth mode clutch 580. The second gear set 585 is coupled to a second synchronizer clutch 586. The CVT 575 includes a third gear set 587 operably coupled to the first-and-third mode clutch 579. The third gear set 587 is operably coupled to a third synchronizer clutch 588. The CVT 575 includes a fourth gear set 589 operably coupled to the second-and-fourth mode clutch 580. The fourth gear set 589 is coupled to a fourth synchronizer clutch 590. The CVT 575 includes a fifth gear set 591 operably coupled to the first-and-third mode clutch 579. The fifth gear set 591 is coupled to a fifth synchronizer clutch 592. In some embodiments, the CVT 575 includes a reverse gear set 593 operably coupled to the first-and-third mode clutch 597. The reverse gear set 593 is operably coupled to a reverse synchronizer clutch 594. The first synchronizer clutch 584, the second synchronizer clutch 586, the third synchronizer clutch 588, the fourth synchronizer clutch 590, the fifth synchronizer clutch 592, and the reverse synchronizer clutch 594 are coupled to a fifth rotatable shaft 595. The fifth rotatable shaft 595 is arranged parallel to the third rotatable shaft 581. In some embodiments, the CVT 575 includes a final drive gear set 596 coupled to a sixth rotatable shaft 597. The sixth rotatable shaft 597 is arranged coaxial to the third rotatable shaft 581. The sixth rotatable shaft 597 is configured to transmit an output power.

Referring now to FIG. 22, during operation of the CVT 575, multiple modes of operation are achieved through engagement of the various clutching devices to provide modes corresponding to overlapping ranges of speed and torque. Typically, the first mode of operation corresponds to a launch mode of a vehicle from a stop. The subsequent modes engaged correspond to higher speed ranges. Likewise, the reverse mode of operation corresponds to a reverse direction of a vehicle equipped with the CVT 575. The table depicted in FIG. 22, lists the modes of operation for the CVT 575 and indicates with an “x” the corresponding clutch engagement. For mode 1 operation, the first-and-third mode clutch 579 and the first synchronizer clutch 584 are engaged. For mode 2 operation, the second-and-fourth mode clutch 580 and the second synchronizer clutch 586 are engaged. For mode 3 operation, the first-and-third mode clutch 579 and the third synchronizer clutch 588 are engaged. For mode 4 operation, the second-and-fourth mode clutch 580 and the fourth synchronizer clutch 590 are engaged. For mode 5 operation, the first-and-third mode clutch 579 and the fifth synchronizer clutch 592 are engaged. For reverse mode operation, the second-and-fourth mode clutch 580 and the reverse synchronizer clutch 594 are engaged. In some embodiments, the powersplit variator 576 is provided with a locking clutch such as the powersplit variators depicted in FIGS. 5-8. In these embodiments, the locking clutch is optionally configured to selectively engage during operation to provide a fixed ratio operating mode as an optional gear in any of the six modes of operation depicted in FIG. 22. During fixed ratio operating modes, power is transmitting through fixed gear ratios and the variator operates at a 1:1 speed ratio without transmitting any power. For example, engagement of the locking clutch in mode 1 provides a fixed ratio for vehicle launch from a stop. The locking clutch can be disengaged when a desired vehicle speed is reach and the vehicle continues to operate in mode 1 with power transmitted through the variator. The locking clutch can be engaged during mode 2, mode 3, mode 4, mode 5 or reverse operation to transmit power through fixed gear ratios and effectively bypass the variator.

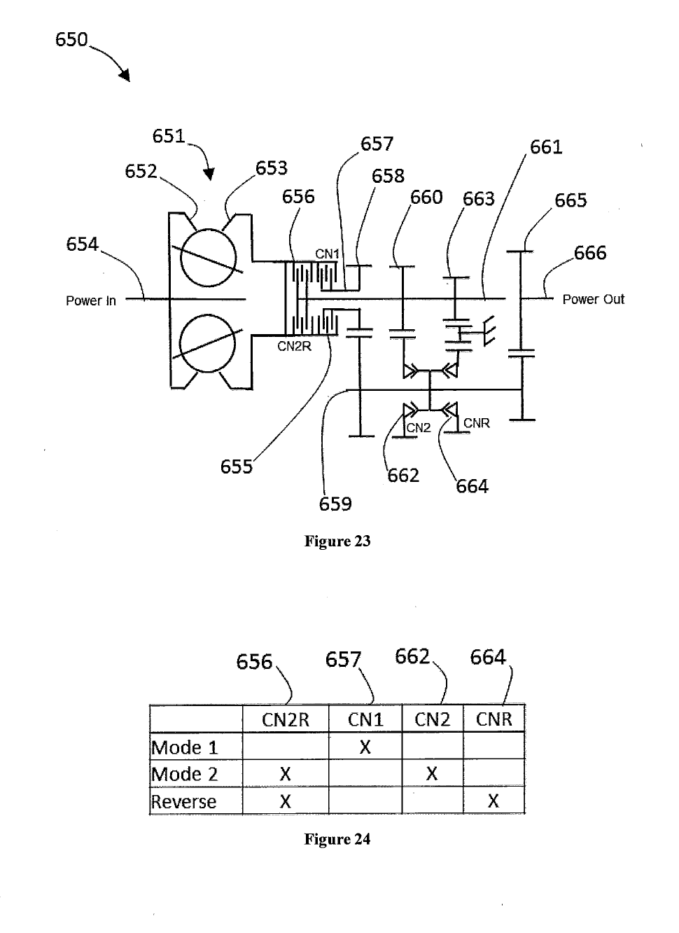

Referring now to FIG. 23, in some embodiments; a continuously variable transmission (CVT) 650 includes a variator 651 having a first traction ring assembly 652 and a second traction ring assembly 653. A first rotatable shaft 654 operably couples to the first traction ring assembly 654. In some embodiments, the variator 651 is configured such as the variators described in FIGS. 1-8. The first rotatable shaft 654 is configured to operably couple to a source of rotational power (not shown). The second traction ring assembly 653 is operably coupled to a first mode clutch 655 and a second-and-reverse mode clutch 656. In some embodiments, the CVT 650 includes a second rotatable shaft 657 arranged coaxial to the first rotatable shaft 654. The second rotatable shaft 657 is operably coupled to the first mode clutch 655. In some embodiments, the CVT 650 includes a third rotatable shaft 661 arranged coaxial to the second rotatable shaft 657. The third rotatable shaft 661 is configured as a hollow shaft through which the second rotatable shaft 657 is positioned. The second-and-reverse mode clutch 656 is coupled to the third rotatable shaft 661.

Still referring to FIG. 23, in some embodiments; the CVT 650 includes a first gear set 658 operably coupled to the first mode clutch 655. The CVT 650 includes a second gear set 660 operably coupled to the second-and-reverse mode clutch 656. The second gear set 660 is coupled to a second synchronizer clutch 662. The CVT 650 includes a reverse gear set 663 operably coupled to a reverse synchronizer clutch 664. The first gear set 658, the second synchronizer clutch 662, and the reverse synchronizer clutch 664 are coupled to a fourth rotatable shaft 659. The fourth rotatable shaft 659 is arranged parallel to the third rotatable shaft 661. In some embodiments, the CVT 650 includes a final drive gear set 665 coupled to a fifth rotatable shaft 666. The fifth rotatable shaft 666 is arranged coaxial to the third rotatable shaft 661. The fifth rotatable shaft 666 is configured to transmit an output power.

Referring now to FIG. 24, during operation of the CVT 650, multiple modes of operation are achieved through engagement of the various clutching devices to provide modes corresponding to overlapping ranges of speed and torque. Typically, the first mode of operation corresponds to a launch mode of a vehicle from a stop. The subsequent modes engaged correspond to higher speed ranges. Likewise, the reverse mode of operation corresponds to a reverse direction of a vehicle equipped with the CVT 650. The table depicted in FIG. 24, lists the modes of operation for the CVT 650 and indicates with an “x” the corresponding clutch engagement. For mode 1 operation, the first mode clutch 655 is engaged. For mode 2 operation, the second-and-reverse mode clutch 656 and the second synchronizer clutch 662 are engaged. For reverse mode operation, the second-and-reverse mode clutch 656 and the reverse synchronizer clutch 664 are engaged. In some embodiments, the variator 651 is provided with a locking clutch such as the powersplit variators depicted in FIGS. 5-8. In these embodiments, the locking clutch is optionally configured to selectively engage during operation to provide a fixed ratio operating mode as an optional gear in any of the three modes of operation depicted in FIG. 24. During fixed ratio operating modes, power is transmitting through fixed gear ratios and the variator operates at a 1:1 speed ratio without transmitting any power. For example, engagement of the locking clutch in mode 1 provides a fixed ratio for vehicle launch from a stop. The locking clutch can be disengaged when a desired vehicle speed is reach and the vehicle continues to operate in mode 1 with power transmitted through the variator. The locking clutch can be engaged during mode 2, or reverse operation to transmit power through fixed gear ratios and effectively bypass the variator.

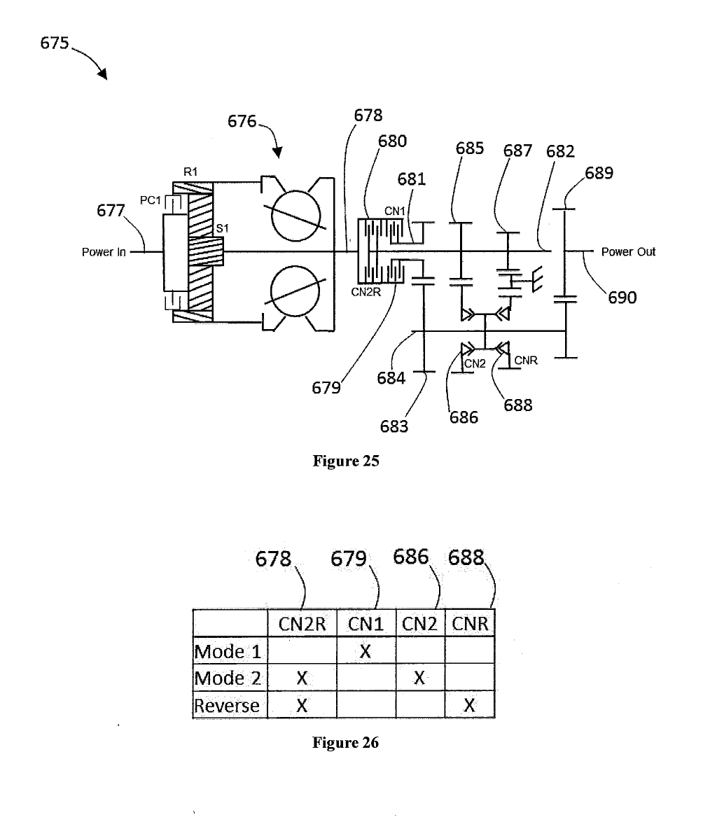

Referring now to FIG. 25, in some embodiments; a continuously variable transmission (CVT) 675 includes a powersplit variator 676 having a first rotatable shaft 677 and a second rotatable shaft 678. In some embodiments, the powersplit variator 676 is configured such as the variators described in FIGS. 1-8. The first rotatable shaft 677 is configured to operably couple to a source of rotational power (not shown). The second rotatable shaft 678 is coupled to a first mode clutch 679 and a second-and-reverse mode clutch 680. In some embodiments, the CVT 675 includes a third rotatable shaft 681 arranged coaxial to the second rotatable shaft 678. The third rotatable shaft 681 is operably coupled to the first mode clutch 679. In some embodiments, the CVT 675 includes a fourth rotatable shaft 682 arranged coaxial to the third rotatable shaft 681. The fourth rotatable shaft 682 is configured as a hollow shaft through which the third rotatable shaft 681 is positioned. The second-and-reverse mode clutch 680 is coupled to the fourth rotatable shaft 682.

Still referring to FIG. 25, in some embodiments; the CVT 675 includes a first gear set 683 operably coupled to the first mode clutch 679. The CVT 675 includes a second gear set 685 operably coupled to the second-and-reverse mode clutch 680. The second gear set 685 is coupled to a second synchronizer clutch 686. The CVT 675 includes a reverse gear set 687 operably coupled to a reverse synchronizer clutch 688. The first gear set 683, the second synchronizer clutch 686, and the reverse synchronizer clutch 688 are coupled to a fifth rotatable shaft 684. The fifth rotatable shaft 684 is arranged parallel to the third rotatable shaft 681. In some embodiments, the CVT 675 includes a final drive gear set 689 coupled to a sixth rotatable shaft 690. The sixth rotatable shaft 690 is arranged coaxial to the third rotatable shaft 681. The sixth rotatable shaft 690 is configured to transmit an output power.

Referring now to FIG. 26, during operation of the CVT 675, multiple modes of operation are achieved through engagement of the various clutching devices to provide modes corresponding to overlapping ranges of speed and torque. Typically, the first mode of operation corresponds to a launch mode of a vehicle from a stop. The subsequent modes engaged correspond to higher speed ranges. Likewise, the reverse mode of operation corresponds to a reverse direction of a vehicle equipped with the CVT 675. The table depicted in FIG. 26, lists the modes of operation for the CVT 675 and indicates with an “x” the corresponding clutch engagement. For mode 1 operation, the first mode clutch 679 is engaged. For mode 2 operation, the second-and-reverse mode clutch 680 and the second synchronizer clutch 686 are engaged. For reverse mode operation, the second-and-reverse mode clutch 689 and the reverse synchronizer clutch 688 are engaged. In some embodiments, the powersplit variator 676 is provided with a locking clutch such as the powersplit variators depicted in FIGS. 5-8. In these embodiments, the locking clutch is optionally configured to selectively during operation to provide a fixed ratio operating mode as an optional gear in any of the three modes of operation depicted in FIG. 26. During fixed ratio operating modes, power is transmitting through fixed gear ratios and the variator operates at a 1:1 speed ratio without transmitting any power. For example, engagement of the locking clutch in mode 1 provides a fixed ratio for vehicle launch from a stop. The locking clutch can be disengaged when a desired vehicle speed is reach and the vehicle continues to operate in mode 1 with power transmitted through the variator. The locking clutch can be engaged during mode 2, or reverse operation to transmit power through fixed gear ratios and effectively bypass the variator. It should be appreciated that the CVTs described herein depicted multiple modes of operation, and that it is within a designer's means to configure the CVTs described herein to have two, three, four, five, or more modes to suit a particular application.

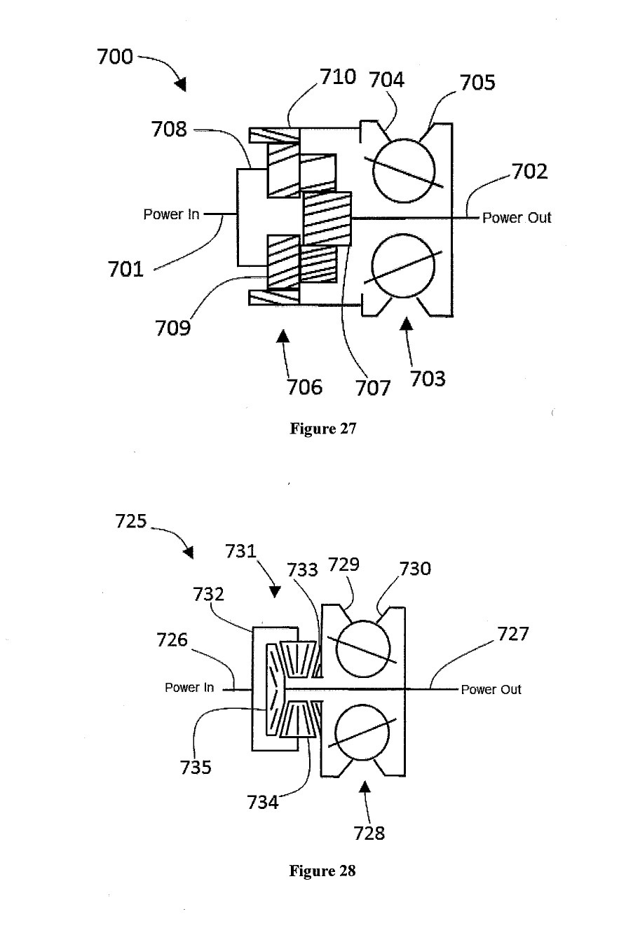

Turning now to FIGS. 27-30, embodiments of powersplit variators that are implementable in the continuously variable transmissions disclosed herein will be described. It should be appreciated that it is within a designers means to use a variety of powersplit variator configurations with the continuously variable transmission configurations described to achieve desired operating and packaging parameters.

Referring to FIG. 27, in some embodiments, a powersplit variator 700 includes a first rotatable shaft 701 adapted to receive power from a source of rotational power (not shown). The powersplit variator 700 includes a second rotatable shaft 702 adapted to transmit a rotational power out of the powersplit variator 700. For example, the second rotatable shaft 702 is adapted to couple to a multiple speed gear box (not shown) to provide multiple modes of operation. In some embodiments, the second rotatable shaft 702 is adapted to couple to a fixed ratio automatic transmission such as well-known multiple speed automatic transmissions or simplified versions thereof utilizing alternative friction plate clutches. In some embodiments, the powersplit variator 700 includes a variator 703. The variator 703 is optionally configured to be a variator similar to the variator depicted in FIGS. 1-3. The variator 703 is provided with a first traction ring assembly 705 and a second traction ring assembly 704. In some embodiments, the powersplit variator 700 includes a planetary gear set 706 having a sun gear 707, a planet carrier 708 configured to support a number of stepped planet gears 709, and a ring gear 710. The ring gear 707 is operably coupled to the second traction ring assembly 704. The sun gear 707 is operably coupled to the second rotatable shaft 702. In some embodiments, the second rotatable shaft 702 is coupled to the first traction ring assembly 705. It should be noted that in some embodiments, the first rotatable shaft 701 is adapted to transmit power out of the powersplit variator 700 and the second rotatable shaft 702 is adapted to operably couple to a source of rotational power.

Referring to FIG. 28, in some embodiments, a powersplit variator 725 includes a first rotatable shaft 726 adapted to receive power from a source of rotational power (not shown). The powersplit variator 725 includes a second rotatable shaft 727 adapted to transmit a rotational power out of the powersplit variator 725. For example, the second rotatable shaft 727 is adapted to couple to a multiple speed gear box (not shown) to provide multiple modes of operation. In some embodiments, the powersplit variator 725 includes a variator 728. The variator 728 is optionally configured to be a variator similar to the variator depicted in FIGS. 1-3. The variator 728 is provided with a first traction ring assembly 730 and a second traction ring assembly 729. In some embodiments, the powersplit variator 725 includes a differential gear set 706 having a planet carrier 731 operably coupled to the first rotatable shaft 726. The planet carrier 731 is configured to support a number of bevel gears 734 of the well-known conical type typically used in differential gear sets. The bevel gears 734 are coupled to a ring gear 733 and a sun gear 735. The ring gear 733 is coupled to the second traction ring assembly 729. The sun gear 735 is coupled to the second rotatable shaft 727. The first traction ring assembly 730 is coupled to the second rotatable shaft 727. It should be noted that in some embodiments, the first rotatable shaft 726 is adapted to transmit power out of the powersplit variator 725 and the second rotatable shaft 727 is adapted to operably couple to a source of rotational power.

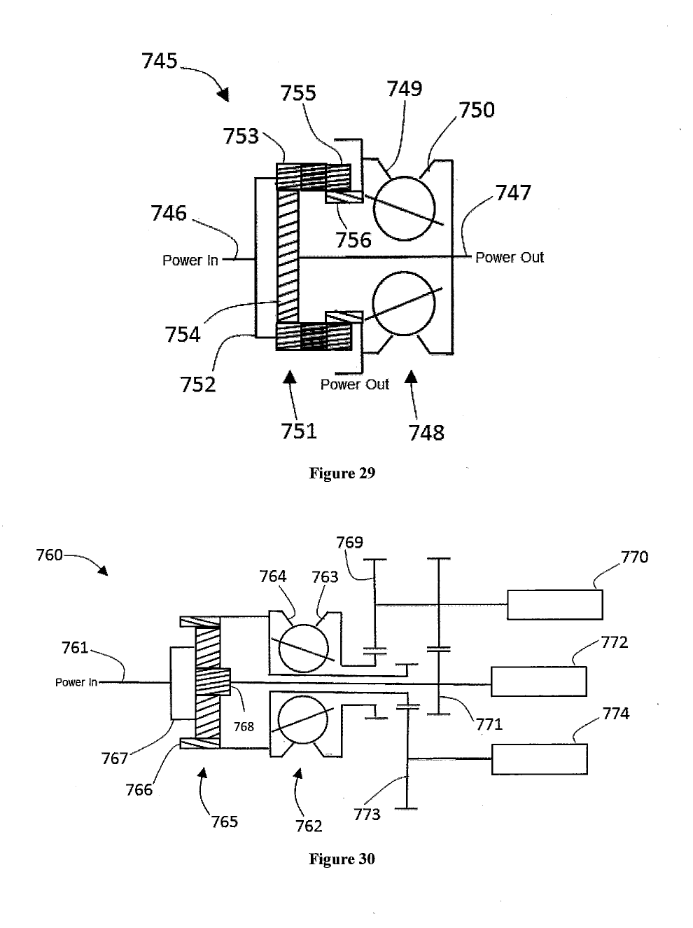

Referring now to FIG. 29, in some embodiments, a powersplit variator 745 includes a first rotatable shaft 746 adapted to receive power from a source of rotational power (not shown). The powersplit variator 745 includes a second rotatable shaft 747 adapted to transmit a rotational power out of the powersplit variator 745. For example, the second rotatable shaft 747 is adapted to couple to a multiple speed gear box (not shown) to provide multiple modes of operation. In some embodiments, the powersplit variator 745 includes a variator 748. The variator 748 is optionally configured to be a variator similar to the variator depicted in FIGS. 1-3. The variator 748 is provided with a first traction ring assembly 750 and a second traction ring assembly 749. In some embodiments, the powersplit variator 745 includes a planetary gear set 751 having a planet carrier 752 configured to support a first array of planet gears 753. The first array of planet gears 753 are coupled to a first sun gear 754. The planet carrier 752 is configured to support a second array of planet gears 755. The second array of planet gears 755 are coupled to a second sun gear 756. The second sun gear 756 is operably coupled to the second traction ring assembly 749. The first sun gear 754 is operably coupled to the second rotatable shaft 747. In some embodiments, the second rotatable shaft 747 is coupled to the first traction ring assembly 750. It should be noted that in some embodiments, the first rotatable shaft 746 is adapted to transmit power out of the powersplit variator 745 and the second rotatable shaft 747 is adapted to operably couple to a source of rotational power. In some embodiments, the second sun gear 756 is configured to provide an optional power output.

Referring now to FIG. 30, in some embodiments, a powersplit variator 760 is provided with a first rotatable shaft 761 adapted to receive power from a source of rotational power. In some embodiments, the first rotatable shaft 761 is operably coupled to a torque converter device, or other common coupling. The powersplit variator 760 is provided with a variator (CVP) 762 aligned coaxially with the first rotatable shaft 761. In some embodiments, the variator 762 is similar to the variator depicted in FIGS. 1-3. The variator 762 includes a first traction ring assembly 763 and a second traction ring assembly 764 in contact with a number of balls. In some embodiments, the powersplit variator 760 includes a planetary gear set 765 aligned coaxially with the first rotatable shaft 761 and the variator 762. The planetary gear set 765 includes a ring gear 766, a planet carrier 767, and a sun gear 768. In some embodiments, the planet carrier 767 is coupled to the first rotatable shaft 761. The ring gear 766 is coupled to the second traction ring assembly 764. In some embodiments, the powersplit variator 760 has a first gear set 769 operably coupled to the first traction ring assembly 763. The first gear set 769 is configured to provide a power output path through a first coupling device 770. In some embodiments, the powersplit variator 760 has a second gear set 771 operably coupled to the sun gear 768 and the first gear set 769. The second gear set 771 is configured to provide a power output path through a second coupling device 772. In some embodiments, the powersplit variator 760 has a third gear set 773 operably coupled to the second traction ring assembly 764. The third gear set 771 is configured to provide a power output path through a third coupling device 774. It should be appreciated that the first coupling device 770, the second coupling device 772, and the third coupling device 773 are optionally configured by a designer to achieve desired performance and packaging of the continuously variable transmission.

It should be noted that the description above has provided dimensions for certain components or subassemblies. The mentioned dimensions, or ranges of dimensions, are provided in order to comply as best as possible with certain legal requirements, such as best mode. However, the scope of the embodiments described herein are to be determined solely by the language of the claims, and consequently, none of the mentioned dimensions is to be considered limiting on the inventive embodiments, except in so far as any one claim makes a specified dimension, or range of thereof, a feature of the claim.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein may be employed in practice. It is intended that the following claims define the scope of the preferred embodiments and that methods and structures within the scope of these claims and their equivalents be covered thereby.

1. A continuously variable transmission comprising:
a first rotatable shaft operably coupleable to a source of rotational power;
a second rotatable shaft coaxial with the first rotatable shaft, the first rotatable shaft and the second rotatable shaft forming a main axis;
a third rotatable shaft aligned parallel to the main axis;
a fourth rotatable shaft arranged coaxial to the main axis, the fourth rotatable shaft configured to transmit an output power;
a variator assembly having a first traction ring assembly and a second traction ring assembly in contact with a plurality of balls, wherein each ball of the plurality of balls has a tiltable axis of rotation, the variator assembly is coaxial with the main axis, the first traction ring assembly is operably coupled to the second rotatable shaft;
a planetary gear set comprising:
a sun gear operably coupled to the second rotatable shaft,
a planet carrier operably coupled to the first rotatable shaft, and
a ring gear coupled to the second traction ring assembly;
a first-and-third mode clutch coaxial with, and coupled to, the third rotatable shaft;
a second-and-fourth mode clutch coaxial with, and coupled to, the third rotatable shaft;
a first gear set operably coupled to the first-and-third mode clutch;
a second gear set operably coupled to the second-and-fourth mode clutch;
a third gear set operably coupled to the first-and-third mode clutch;
a fourth gear set operably coupled to the second-and-fourth mode clutch;
a first synchronizer clutch operably coupled to the first gear set;
a second synchronizer clutch operably coupled the second gear set;
a third synchronizer clutch operably coupled to the third gear set; and
a fourth synchronizer clutch operably coupled to the fourth gear set,
wherein the first synchronizer clutch, the second synchronizer clutch, the third synchronizer clutch, and the fourth synchronizer clutch are operably coupled to, and coaxial to, the fourth rotatable shaft.

2. The continuously variable transmission of claim 1, further comprising a reverse synchronizer clutch operably coupled to and coaxial to the fourth rotatable shaft.

3. The continuously variable transmission of claim 1, further comprising a locking clutch operably coupled to the planetary gear set, wherein the locking clutch is adapted to selectively engage a fixed ratio mode of operation.

4. A continuously variable transmission comprising:
a first rotatable shaft operably coupleable to a source of rotational power;
a second rotatable shaft coaxial with the first rotatable shaft, the first rotatable shaft and the second rotatable shaft forming a main axis;
a third rotatable shaft aligned parallel to the main axis;
a fourth rotatable shaft arranged coaxial with the third rotatable shaft, the third rotatable shaft and the fourth rotatable shaft forming a counter axis;
a fifth rotatable shaft arranged coaxial to the main axis, the fifth rotatable shaft configured to transmit an output power;
a variator assembly having a first traction ring assembly and a second traction ring assembly in contact with a plurality of balls, wherein each ball of the plurality of balls has a tiltable axis of rotation, the variator assembly is coaxial with the main axis, the first traction ring assembly is operably coupled to the second rotatable shaft;
a planetary gear set comprising:
a sun gear operably coupled to the second rotatable shaft,
a planet carrier operably coupled to the first rotatable shaft, and
a ring gear coupled to the second traction ring assembly;
a first-and-third mode clutch coaxial with, and coupled to, the second rotatable shaft;
a second-and-fourth mode clutch coaxial with, and coupled to, the second rotatable shaft;
a first-and-third mode gear set operably coupled to the first-and-third mode clutch, the first-and-third mode gear set operably coupled to the third rotatable shaft;
a second-and-fourth mode gear set operably coupled to the second-and-fourth mode clutch, the second-and-fourth mode gear set operably coupled to the fourth rotatable shaft;
a first gear set operably coupled to the third rotatable shaft;
a second gear set operably coupled to the fourth rotatable shaft;
a third gear set operably coupled to the third rotatable shaft;
a fourth gear set operably coupled to the fourth rotatable shaft;
a first synchronizer clutch operably coupled to the first gear set;
a second synchronizer clutch operably coupled the second gear set;
a third synchronizer clutch operably coupled to the third gear set; and
a fourth synchronizer clutch operably coupled to the fourth gear set,
wherein the first synchronizer clutch, the second synchronizer clutch, the third synchronizer clutch, and the fourth synchronizer clutch are operably coupled to, and coaxial to, the fifth rotatable shaft.

5. The continuously variable transmission of claim 4, further comprising a reverse synchronizer clutch operably coupled to and coaxial to the fifth rotatable shaft.

6. The continuously variable transmission of claim 4, further comprising a locking clutch operably coupled to the planetary gear set, wherein the locking clutch is adapted to selectively engage a fixed ratio mode of operation.

7. A continuously variable transmission comprising:
a first rotatable shaft operably coupleable to a source of rotational power;
a second rotatable shaft coaxial with the first rotatable shaft, the first rotatable shaft and the second rotatable shaft forming a main axis;
a third rotatable shaft aligned parallel to the main axis;
a fourth rotatable shaft arranged coaxial to the main axis, the fourth rotatable shaft arranged parallel to the third rotatable shaft;
a fifth rotatable shaft arranged coaxial with the fourth rotatable shaft;
a sixth rotatable shaft arranged coaxial with the fifth rotatable shaft, the sixth rotatable shaft configured to transmit an output power;
a variator assembly having a first traction ring assembly and a second traction ring assembly in contact with a plurality of balls, wherein each ball of the plurality of balls has a tiltable axis of rotation, the variator assembly is coaxial with the main axis, the first traction ring assembly is operably coupled to the second rotatable shaft;
a planetary gear set comprising:
a sun gear operably coupled to the second rotatable shaft,
a planet carrier operably coupled to the first rotatable shaft, and
a ring gear coupled to the second traction ring assembly;
a first-and-third mode clutch coaxial with, and coupled to, the fourth rotatable shaft;
a second-and-fourth mode clutch coaxial with, and coupled to, the fifth rotatable shaft;
a transfer coupling configured to couple to the second rotatable shaft and the third rotatable shaft;
a first gear set operably coupled to the fourth rotatable shaft;
a second gear set operably coupled to the fifth rotatable shaft;
a third gear set operably coupled to the fourth rotatable shaft;
a fourth gear set operably coupled to the fifth rotatable shaft;
a first synchronizer clutch operably coupled to the first gear set;
a second synchronizer clutch operably coupled the second gear set;
a third synchronizer clutch operably coupled to the third gear set; and
a fourth synchronizer clutch operably coupled to the fourth gear set,
wherein the first synchronizer clutch, the second synchronizer clutch, the third synchronizer clutch, and the fourth synchronizer clutch are operably coupled to, and coaxial to, the third rotatable shaft.

8. The continuously variable transmission of claim 7, further comprising a reverse synchronizer clutch operably coupled to and coaxial to the third rotatable shaft.

9. The continuously variable transmission of claim 7, wherein the transfer coupling further comprises a plurality of meshing gears.

10. The continuously variable transmission of claim 7, further comprising a locking clutch operably coupled to the planetary gear set, wherein the locking clutch is adapted to selectively engage a fixed ratio mode of operation.

11-24. (canceled)
